(19) United States
(12) Patent Application Publication
(10) Pub. No.: US 2020/0313455 A1
(43) Pub. Date: Oct. 1, 2020

(54) MULTIFUNCTION UNIT INCLUDING A POWER MODULE

(71) Applicant: EDGEWORKS INNOVATIONS LLC, Chagrin Falls, OH (US)

(72) Inventors: Richard C. Adamany, Chagrin Falls, OH (US); Bennett S. Rubin, Chagrin Falls, OH (US)

(21) Appl. No.: 16/311,225

(22) PCT Filed: Jul. 5, 2017
(86) PCT No.: PCT/US2017/040683

§ 371 Date: Dec. 19, 2018

Related U.S. Application Data
(60) Provisional application No. 62/359,728, filed on Jul. 8, 2016.

(51) Int. Cl. H02J 7/34; H01M 10/0525; H02J 7/00; F21L 4/00; F04B 35/04

(52) U.S. Cl. CPC H02J 7/342; H01M 10/0525; H01M 2220/30; F21L 4/00; F04B 35/04; H02J 7/0042

(57) ABSTRACT

A multifunction unit includes a power module for powering an accessory module docked thereon. The unit allows docking of multiple accessory modules to the module, including multiple differing accessories such as lights, compressors and jumper cables. The unit may include multiple docking locations, each docking location capable of powering a different accessory at different power ratings.

### REFERENCE TO RELATED APPLICATION

This application claims priority of U.S. provisional patent application Ser. No. 62/359,728, entitled Multifunction Unit Including a Power Module and an Accessory Module, filed Jul. 8, 2016, and hereby incorporates this provisional patent application by reference herein in its entirety.

### TECHNICAL FIELD

The apparatus and methods described below generally relate to a modular multifunction unit having a power module for powering various accessory modules docked thereon.

### BACKGROUND

Conventional portable vehicular battery chargers enable remote charging of a vehicle battery. However, these conventional battery chargers are bulky, lack modularity, and lack the capability to communicate with a remote computing device, such as a smartphone, for example.

### SUMMARY

In accordance with one embodiment, a multifunction unit comprises a power module, an accessory module, and a locking mechanism. The power module comprises a power storage device that is configured to store electrical power. The power module further comprises a first docking location. The accessory module is configured for selective docking on the power module at the first docking location. The locking mechanism is movably coupled with one of the power module and the accessory module and movable between a locked position and an unlocked position to facilitate selective securement of the power module and the accessory module together when the accessory module is docked on the power module.

In accordance with another embodiment, a power module for a multifunction unit is provided. The power module comprises a housing, a power storage device, a first power output, and a second power output. The housing comprises a first docking location and a second docking location. The first docking location comprises a first surface that is substantially planar and resides in a first plane. The second docking location is opposite the first docking location and comprises a second surface that is substantially planar and resides in a second plane. The power storage device is disposed at least partially within the housing. The first power output is located at the first surface of the first docking location. The first power output is in electrical communication with the power storage device and is configured to deliver power at a first power rating. The second power output is located at the second surface of the second docking location. The second power output is in electrical communication with the power storage device and is configured to deliver power at a second power rating. The first surface and the second surface are spaced from each other and are arranged such that the first plane and the second plane are substantially parallel with each other. The first power rating is greater than the second power rating.

In accordance with yet another embodiment, a multifunction unit comprises a power module and a light module. The power module comprises a first housing, a first power storage device, and a power output. The first housing comprises a docking location. The first power storage device is configured to store electrical power. The power output is located at the docking location and is in electrical communication with the first power storage device. The light module is configured for selective docking on the power storage device at the docking location. The light module comprises a second housing, an illumination device, a second power storage device, a power input, and a magnetic coupling arrangement. The second housing comprises a power module docking interface that interfaces with the power module at the docking location when the light module is docked on the power module. The illumination device is coupled with the second housing and is configured to emit light. The second power storage device is at least partially disposed within the second housing and is configured to store electrical power. The second power storage device is in electrical communication with the illumination device such that the illumination device is powered from the second power storage device. The power input is located at the power module docking interface. The power input is in electrical communication with the power output of the power module when the light module is docked on the power module such that the second power storage device is powered from the first power storage device. The magnetic coupling arrangement is associated with each of the power module and the light module to facilitate selective retention of the power module and the light module together when the light module is docked on the power module.

### BRIEF DESCRIPTION OF THE DRAWINGS

Various embodiments will become better understood with regard to the following description, appended claims and accompanying drawings wherein:

FIG. 1 is a front isometric view depicting a multifunction unit, in accordance with one embodiment, with an air compressor hose shown associated with the multifunction unit;

FIG. 2 is a rear isometric view depicting the multifunction unit of FIG. 1, with a jumper cable shown associated with the multifunction unit;

FIG. 3 is a rear exploded isometric view depicting the multifunction unit of FIG. 1;

FIG. 4 is schematic view depicting a light module, a power module, and an air compressor module of the multifunction unit of FIG. 1;

FIG. 5 is a rear isometric view depicting the power module of the multifunction unit of FIG. 1;

FIG. 6 is a front isometric view depicting the power module of FIG. 5;

FIG. 7 is a rear isometric view depicting the light module of the multifunction unit of FIG. 1 with a hook shown in a stored position;

FIG. 8 is a front isometric view depicting the light module of FIG. 7, but with the hook shown in a deployed position;

FIG. 9 is a rear isometric view depicting the air compressor module of the multifunction unit of FIG. 1;

FIG. 10 is a front isometric view depicting the air compressor module of FIG. 9;

FIG. 11 is a rear isometric view depicting the power module of FIG. 5 in association with latches of the air compressor module depicted in FIGS. 9 and 10, wherein various other components of the air compressor module have been removed for clarity of illustration;

FIG. 12 is a front isometric view depicting a jumper cable storage module of the multifunction unit of FIG. 1; and

FIG. 13 is a schematic view depicting a smart phone having a graphical user interface displayed thereon.

### DETAILED DESCRIPTION

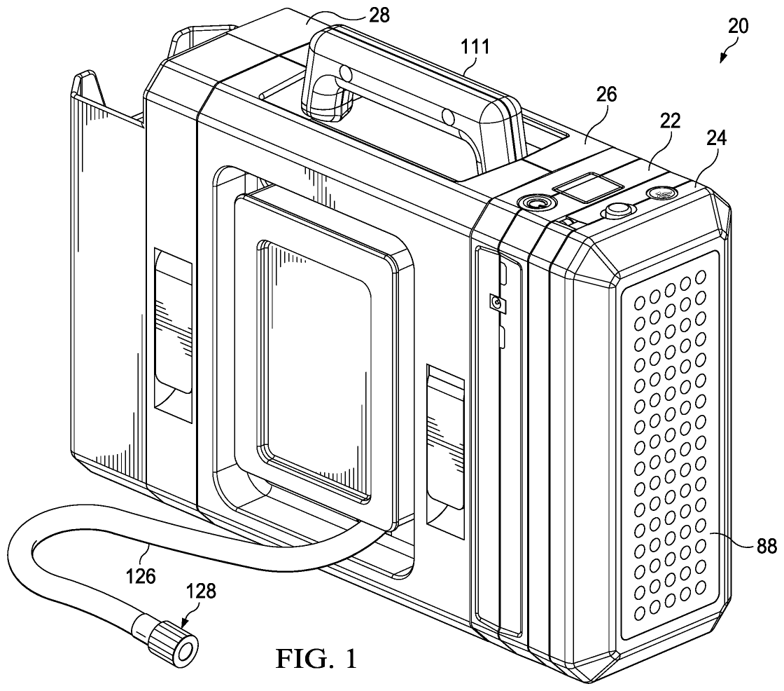

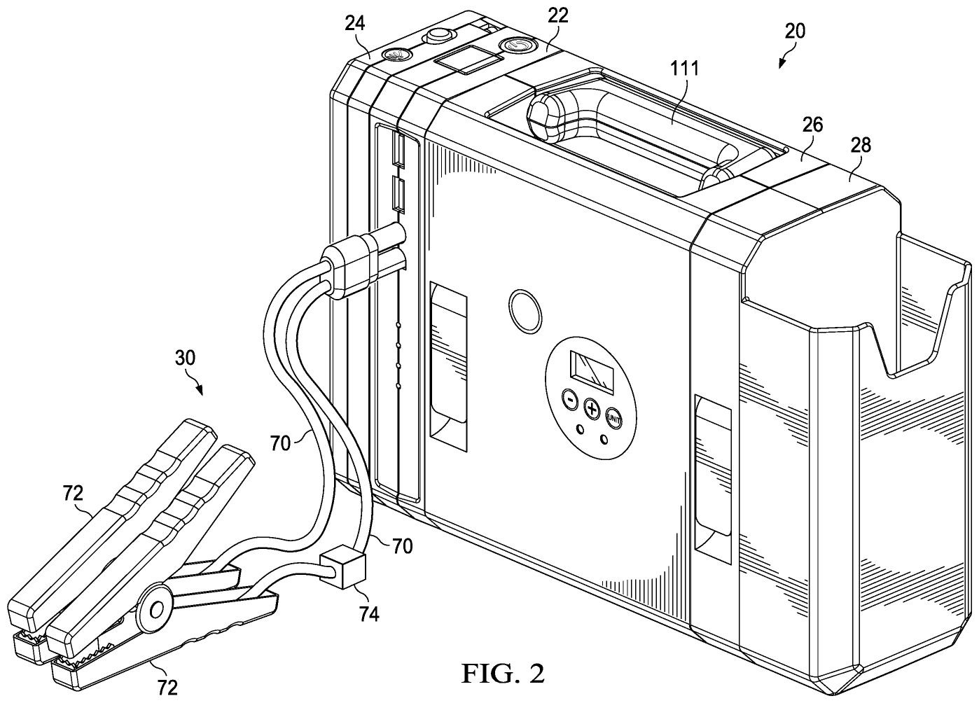

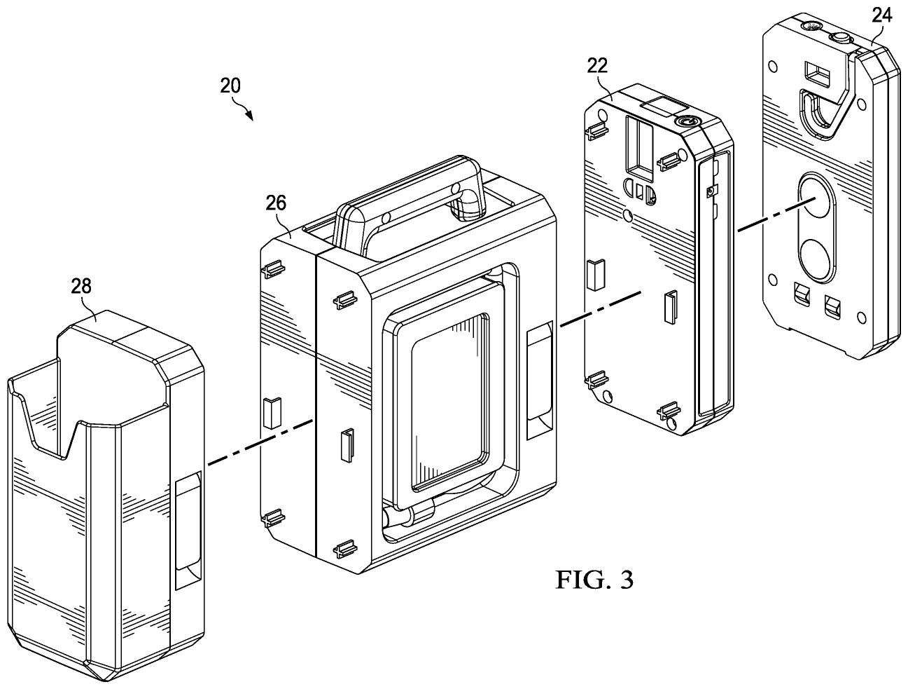

Embodiments are hereinafter described in detail in connection with the views and examples of FIGS. 1-13, wherein like numbers indicate the same or corresponding elements throughout the views. As illustrated in FIGS. 1-3, a multifunction unit 20 can include a power module 22, a light module 24 and air compressor module 26 each releasably mounted on opposite sides of the power module 22. As will be described in further detail below, the power module 22 can provide electrical power to each of the light module 24 and air compressor module 26. A jumper cable storage module 28 can also be attached to the air compressor module 26 for storage of a jumper cable 30 (FIG. 2) therein.

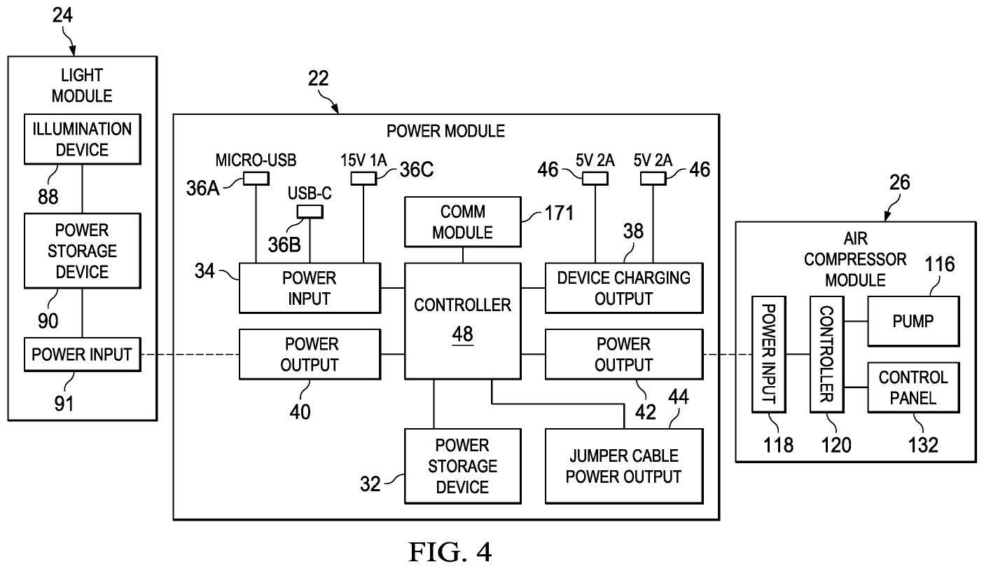

Referring now to FIG. 4, the power module 22 can include a power storage device 32 that is configured to store electrical power. In one embodiment, the power storage device 32 can be a lithium ion battery. In other embodiments, the power storage device 32 can be a nickel cadmium battery, a lead acid battery, a super capacitor, or any of a variety of other arrangements capable of storing electrical power. The power storage device 32 can be in electrical communication with a power input 34 that can receive electrical power for charging the power storage device 32. The power input 34 can have different charging ports 36A, 36B, 36C that allow for connection of a charging cable to the power input 34. Each of the different charging ports 36A, 36B, 36C can be configured to receive a different type of power cable for charging the power storage device 32. For example, one charging port 36A can be a Micro-USB port, one charging port 36B can be a USB-C port, and the other charging port 36C can be a coaxial power connector rated for 15 Volts DC at 1 Amp.

It is to be appreciated that the power input 34 can include any of a variety of suitable additional or alternative ports for connecting with different types of charging cables from a remote power source (e.g., a 120 VAC wall receptacle) to facilitate charging of the power storage device 32. The power module 22 can additionally or alternatively include a photovoltaic panel (e.g., a solar panel), a hand crank generator, or any other suitable device that can deliver power to the power storage device 32.

The power storage device 32 can also be in electrical communication with each of a device charging output 38, a power output 40, a power output 42, and a jumper cable power output 44 for the delivery of electrical power thereto. The device charging output 38 is shown to have two USB charging ports 46 (rated for 5 Volts DC at 2 Amps) that can allow for connection of a USB cable to facilitate charging of an electronic device (e.g., a mobile phone) from the power module 22. It is to be appreciated that the device charging output 38 can include any of a variety of suitable additional or alternative ports for allowing for charging of different types of electronic devices. As will be described in further detail below, each of the power output 40, the power output 42, and the jumper cable power output 44 can facilitate the delivery of power to the light module 24, the air compressor module 26, and the jumper cable 30, respectively. Each of the power output 40, the power output 42, and the jumper cable power output 44 can be configured to deliver power at respective power ratings that are appropriate for each of the light module 24, the air compressor module 26, and the jumper cable 30, respectively. For example, the power rating of the power output 40 can be less than the power ratings of each of the power output 42 and the jumper cable power output 44 since the light module 24 can impart less of an electrical load on the power storage device 32 than the air compressor module 26 or a vehicle battery that is being charged with the jumper cable 30.

Still referring to FIG. 4, the power storage device 32 can be in communication with each of the power input 34, the device charging output 38, the power output 40, the power output 42, and the jumper cable power output 44 via a controller 48. The controller 48 can be configured to control the power flow from the power input 34 and to each of the device charging output 38, the power output 40, the power output 42, and the jumper cable power output 44. For example, when a power source is coupled with the power input 34 to charge the power storage device 32, the controller 48 can monitor the power flow and can selectively disconnect the power storage device 32 from the power input 34 when conditions occur that might damage the power storage device 32 and/or the power input 34, such as due to overcurrent or when an improper power supply is coupled with the power input 34. In addition, the controller 48 can control the power rating of the power that is distributed to each of the device charging output 38, the power output 40, the power output 42, and the jumper cable power output 44. The controller 48 can accordingly include any of a variety of electronic devices (not shown) that facilitate control over the power rating, such as, for example, transformers, transistors, diodes, and inverters. The controller 48 can also include various protection schemes, such as, overcurrent protection, that protects the power storage device 32 from damage due to abnormal conditions or misuse. It is to be appreciated that the controller 48 can be any suitable processor-based, computing-type arrangement such as an integrated circuit, for example, and can include hardware, software (for example, in execution), and/or firmware.

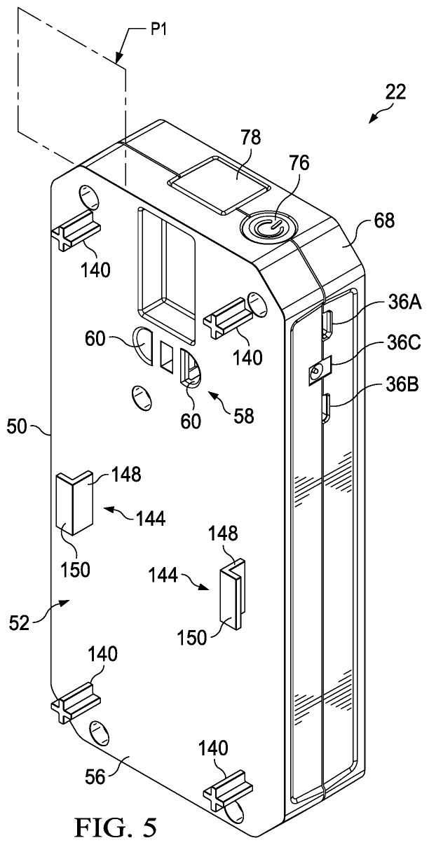

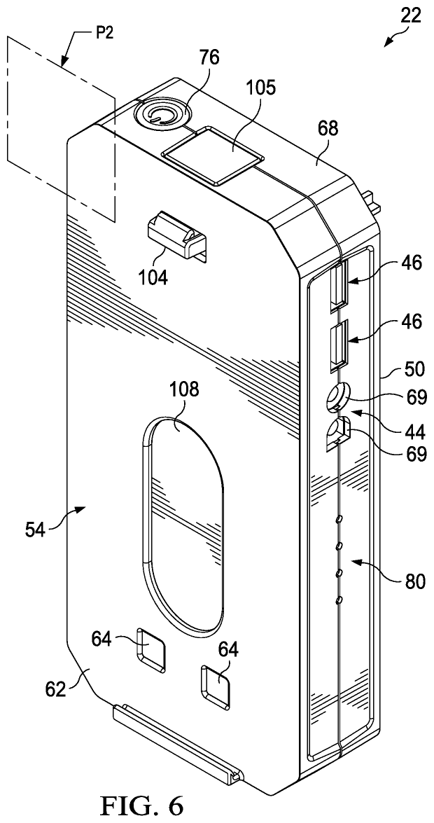

Referring now to FIGS. 5 and 6, the power module 22 can include a housing 50 within which the power storage device 32 is disposed. The housing 50 can comprise a docking location 52 (FIG. 5) and a docking location 54 (FIG. 6). As illustrated in FIGS. 1-3, the air compressor module 26 can be docked on the docking location 52 and the light module 24 can be docked on the docking location 54. Referring to FIG. 5, the docking location 52 can include a docking surface 56 that is substantially planar and resides in a plane P1. The power output 42 can comprise a socket 58 that is located at the docking surface 56. The socket 58 can have a power rating for the delivered power that is sufficient enough to facilitate powering of the air compressor module 26. In one embodiment, the power rating of the socket 58 can be about 60 Watts (5 Amps at 12 VDC). Considering the significant amount of power available, the socket 58 can include a pair of holes 60 which conceals electrical contacts (not shown) thereby preventing a user's finger from making physical contact with the electrical contacts.

Referring now to FIG. 6, the docking location 54 can include a docking surface 62 that is substantially planar and resides in a plane P2. The docking surfaces 56, 62 can be spaced from each other and can be arranged such that the planes P1, P2 are substantially parallel with each other. The power output 40 can comprise a pair of conductive pads 64 that are located at the docking surface 62. The conductive pads 64 can have a power rating that is sufficient enough to facilitate powering of the light module 24. The light module 24 can require significantly less power than the air compressor module 26. The power rating of the conductive pads 64 can accordingly be less than the power rating of the socket 58 (FIG. 5). In one embodiment, the power rating of the conductive pads 64 can be about 1.5 Watts (300 milliamps at 5 VDC).

Referring again to FIGS. 5 and 6, the power module 22 can include an outer surface 68 that extends between the docking surfaces 56, 62. As illustrated in FIG. 6, the jumper cable power output 44 can include a pair of receptacles 69 that are located on the outer surface 68. The jumper cable 30 can be plugged into the receptacles 69 of the jumper cable power output 44, as illustrated in FIG. 2, to facilitate charging of a vehicular battery with the power module 22. One of the receptacles 69 is shown to be substantially D-shaped to prevent the jumper cable 30 from being attached in a reverse polarity. It is to be appreciated that the receptacle(s) 69 and/or jumper cable 30 can be provided with any of a variety of suitable additional or alternative features that prevent the jumper cable 30 from being incorrectly plugged into the jumper cable power output 44. Still referring to FIG. 2, the jumper cable 30 can include a pair of cables 70 with clamps 72 that can be selectively attached to terminals of an automotive battery (not shown). The cables 70 and/or clamps 72 can each be provided with a color (e.g., red or black) or other indicia indicating the polarity of the cables 70 and/or clamps 72. The clamps 72 can be selectively stored in the jumper cable storage module 28. The clamps 72 can be configured such that they can nest together when inserted into the jumper cable storage module 28. The jumper cable 30 can additionally include a protection device 74 that is configured to prevent damage due to abnormal conditions or misuse (e.g., connecting the clamps 72 in a reverse polarity).

The jumper cable 30 can require significantly more power when charging a vehicular battery than may be required by the light module 24 or the air compressor module 26. As such, the power rating of the jumper cable power output 44 can be greater than the power rating of either of the socket 58 or the conductive pads 64. In one embodiment, the power rating of the jumper cable power output 44 can be about 150 Watts (12.5 Amps at 12 VDC with a maximum peak current of about 100 Amps). Considering the significant amount of power available, the jumper cable power output 44 can facilitate concealment of the electrical contacts (not shown) that electrically connect with the jumper cable 30, thereby preventing a user's finger from making physical contact with the electrical contacts. It is to be appreciated that the power module 22 can be operable to charge a vehicular battery (e.g., with the jumper cable 30) without either of the light module 24 or the air compressor module 26 being docked on the power module 22 such that the power module 22 can be deployed as a stand-alone battery charger that is compact and easy to store (e.g., in a vehicular trunk).

As illustrated in FIGS. 5 and 6 respectively, the charging ports 36A, 36B, 36C and the USB charging ports 46 can be distributed along the outer surface 68 of the power module 22. In addition, the power module 22 can include a power button 76 that is disposed on the outer surface 68 and can be manually depressed to turn the power module 22 on and off (e.g., to facilitate selective interruption of the flow of electricity between the power storage device 32 and the outputs 36, 38, 40, 42, 44). In one embodiment, the controller 48 of the power module 22 can initiate a sleep mode that automatically powers the power module 22 down after a period of non-use (e.g., no power being distributed from any of the various outputs 36, 38, 40, 42, 44).

The power module 22 can also include an array of indicator lights 80 that are selectively illuminated to indicate the current charge level of the power storage device 32.

It is to be appreciated the power module 22 can be compact and thus easily portable. The overall size and thickness of the power module 22 can be dictated by the type and capacity of the power storage device 32 employed within the power module 22. For the power module 22 illustrated in the FIGS. 1-6, a lithium ion battery can be used that has three 3.6 VDC serially connected cells that cooperate to provide an overall capacity of 10 Amp-Hours for the power module 22. It is to be appreciated that the power storage device 32 provided in the power module 22 can be tailored to the particular powering environment in which the power module 22 is deployed. For example, when the multifunction unit 20 is intended for use in a commercial trucking environment (e.g., for charging a battery of a tractor trailer), the power storage device 32 can have a larger capacity (e.g., 25 Amp Hours) which can result in a power module 22 with a larger form factor than that shown in FIGS. 1-6.

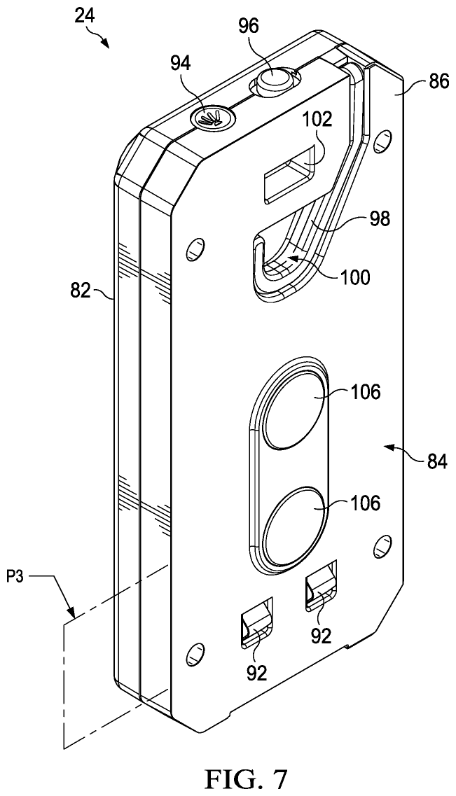

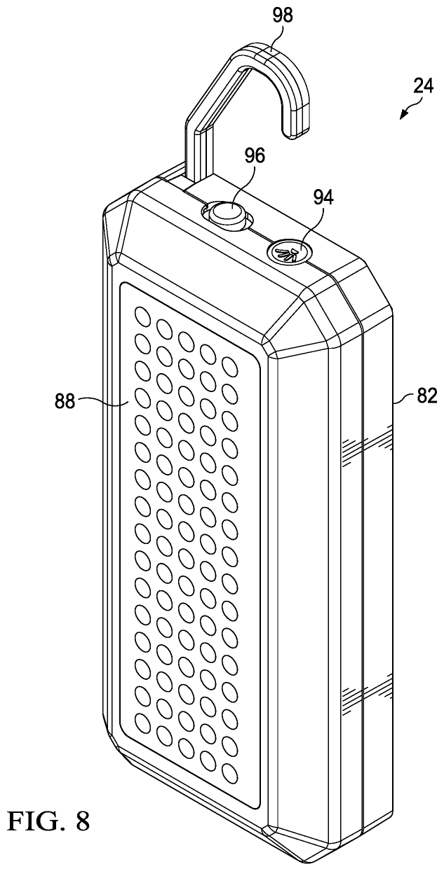

Referring now to FIGS. 7 and 8, the light module 24 will now be described. The light module 24 can include a housing 82 that includes a docking interface 84 that is configured to interface with the power module 22 at the docking location 54 (FIG. 6) when the light module 24 is docked on the power module 22. The docking interface 84 can include an interface surface 86 that is substantially planar and resides in a plane P3. When the light module 24 is docked on the power module 22, the docking surface 62 (FIG. 6) and the interface surface 86 can abut such that the plane P2 and the plane P3 are substantially parallel.

The light module 24 can include an illumination device 88 (FIG. 8) that is mounted on the housing 82 and configured to distribute light to a surrounding environment. In one embodiment, the illumination device 88 can comprise an array of light emitting diodes but in other embodiments can additionally or alternatively be any of a variety of suitable alternative lighting arrangements, such as incandescent and/or fluorescent bulbs or other suitable illuminating feature.

The illumination device 88 can be in electrical communication with a power storage device 90 (FIG. 4) that is configured to store electrical power. The power storage device 90 can be a lithium ion battery or any other variety of suitable alternative power storage devices. As illustrated in FIG. 4, the power storage device 90 can be in electrical communication with a power input 91. The power input 91 can comprise electrical contacts 92, as illustrated in FIG. 7, that are provided at interface surface 86. When the light module 24 is docked on the power module 22, the electrical contacts 92 can contact the conductive pads 64 (FIG. 6) on the docking surface 62 of the power module 22 such that electricity from the power storage device 32 of the power module 22 can be delivered to the light module 24 to facilitate charging of the power storage device 90 and/or lighting of the illumination device 88.

The light module 24 can include a power button 94 that can be depressed to turn the illumination device 88 on and off (e.g., to facilitate selective interruption of the flow of electricity between the power storage device 90 and the illumination device 88). The light module 24 can also include an electrical switch 96 that can allow for selection among different lighting modes, such as, for example, constant illumination, flashing, dimming, flashing Morse code signals (e.g., to indicate SOS) and/or different lighting colors.

The light module 24 can be configured to remain operable when removed from the power module 22 such that the light module 24 can be used to light an area away from the power module 22. When removed, the light module 24 can be powered by the power storage device 90. In one embodiment, the light module 24 can include a hook 98 that is pivotally coupled with the housing 82 at the docking interface 84 and is selectively pivotable between a stored position (FIG. 7) and a deployed position (FIG. 8). When the light module 24 is undocked from the power module 22, the light module 24 can be hung by the hook 98 to illuminate a nearby area. As illustrated in FIG. 7, the docking interface 84 can define a receptacle 100 that receives the hook 98 when the hook 98 is in the stored position.

In one embodiment, as illustrated in FIG. 7, the housing 82 can define a slot 102 that is configured to receive an engagement tab 104 of the power module 22 (see FIG. 6). The engagement tab 104 can cooperate with the slot 102 to releasably couple the light module 24 to the power module 22. The engagement tab 104 of the power module 22 is shown to extend from the docking surface 62 in a direction that is substantially orthogonal to the plane P2. As such, the light module 24 can be docked on, or undocked from, the power module 22 in a direction that is orthogonal to the plane P2. An actuation button 105 can be disposed at the outer surface 68 of the power module 22 and can be operably coupled with the engagement tab 104. When the light module 24 is docked on the power module 22, the actuation button 105 can be depressed which can move the engagement tab 104 downwardly and out of engagement from the slot 102 to facilitate releasement of the light module 24 from the power module 22.

The light module 24 can include a pair of magnets 106 that are located at the interface surface 86. In one embodiment, the magnets 106 can be embedded in the interface surface 86. As illustrated in FIG. 6, the power module 22 can include a metal plate 108 that is located at the docking surface 62 of the power module 22. When the light module 24 is docked on the power module 22, the magnets 106 can be attracted to the metal plate 108. The magnets 106 and the metal plate 108 can accordingly cooperate with the engagement tab 104 and the slot 102 to hold the light module 24 in place. In particular, the light module 24 can be removed by first depressing the actuation button 105 and then pulling the light module 24 away from the power module 22 in a direction that is substantially orthogonal to the plane P2 with enough force to overcome the attraction between the magnets 106 and the metal plate 108. Once the light module 24 is undocked, it can be hung on a nearby metal surface using the magnets 106 (in lieu of the hook 98) to illuminate a nearby area. It is to be appreciated that any of a variety of suitable alternative or additional magnetic coupling arrangements are contemplated that are associated with each of the power module 22 and the light module 24 to facilitate selective retention of the power module 22 and the light module 24 together when the light module 24 is docked on the power module 22.

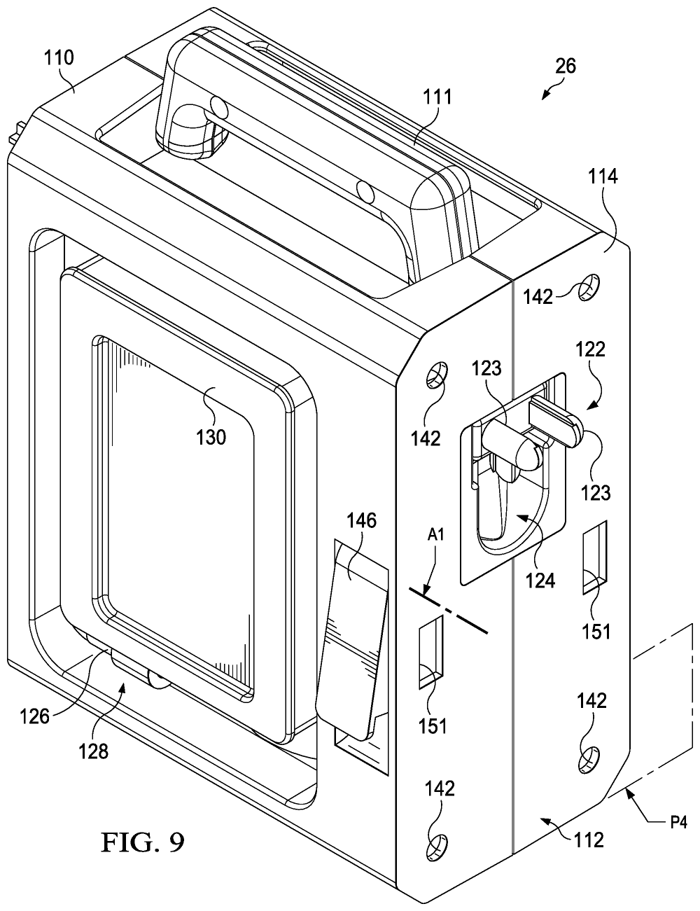

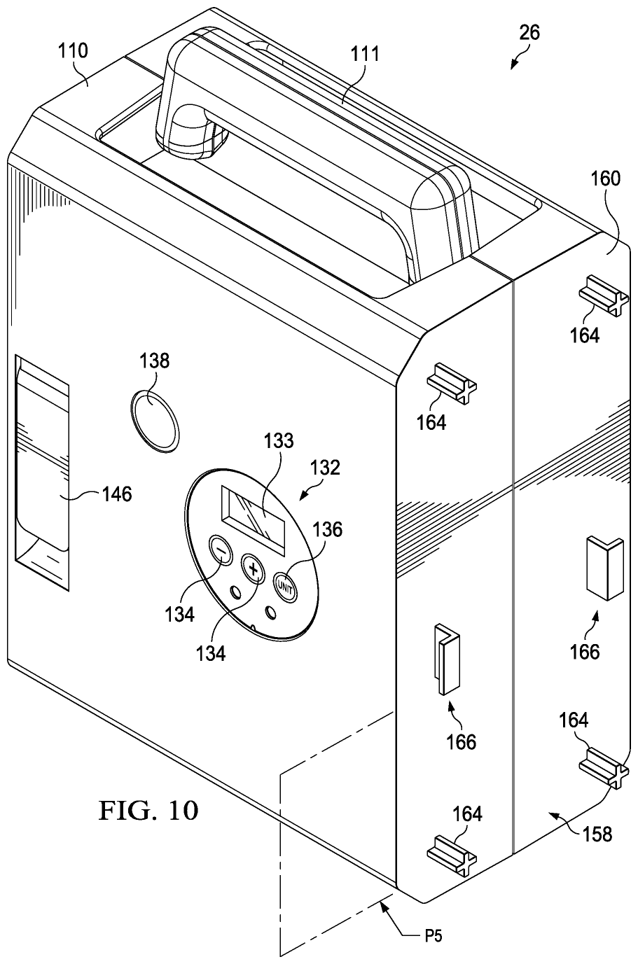

Referring now to FIGS. 9 and 10, the air compressor module 26 will now be described. The air compressor module 26 can include a housing 110 and a handle 111 that facilitates carrying of the multifunction unit 20 by a user. The handle 111 can be pivotally coupled to the housing 110 and configured to pivot between a deployed position (FIG. 1) and a stored position (FIG. 2). The housing 110 can also include a docking interface 112 (FIG. 9) that is configured to interface with the power module 22 at the docking location 52 (FIG. 5) when the air compressor module 26 is docked on the power module 22. The docking interface 112 can include an interface surface 114 that is substantially planar and resides in a plane P4. When the air compressor module 26 is docked on the power module 22, the docking surface 56 and the interface surface 114 can abut such that the plane P1 and the plane P4 are substantially parallel.

As illustrated in FIG. 4, the air compressor module 26 can include a pump 116 that is electrically coupled with a power input 118 via a controller 120. The power input 118 can comprise a plug 122, as illustrated in FIG. 9, having a pair of plug members 123 that extend away from the interface surface 114. When the air compressor module 26 is docked on the power module 22, the plug members 123 can be inserted into the socket 58 on the docking surface 56 of the power module 22 such that electricity from the power storage device 32 of the power module 22 can be delivered to the air compressor module 26 to facilitate powering of the pump 116. In one embodiment, the plug 122 can be selectively pivoted into a receptacle 124 defined by the interface surface 114 to prevent the plug members 123 from inadvertently catching on nearby objects (e.g., during removal and storage of the air compressor module 26). The plug members 123 can have a contoured shape (e.g., a D-shape) that is configured to mate with the socket 58 but that prevents the plug 122 from being plugged into a common AC receptacle (e.g., a 120 VAC or a 220 VAC household receptacle).

The air compressor module 26 can have an air hose 126 (FIGS. 1 and 9) that is in fluid communication with the pump 116. The air hose 126 can have a distal end 128 (FIG. 1) that is configured to enable releasable coupling of the air hose 126 to an item for delivering compressed air to that item. In one embodiment, the distal end 128 can be configured for releasable coupling with a Schrader valve. The housing 110 can include a storage portion 130, and the air hose 126 can be selectively wound around the storage portion 130 to facilitate storage of the air hose 126 on the housing 110 of the air compressor module 26.

Referring now to FIG. 10, the air compressor module 26 can include a control panel 132 that is in electrical communication with the pump 116. The control panel 132 can include a display 133 that is configured to display the current air pressure of the item that is connected to the distal end 128 of the air hose 126. The control panel 132 can also include a pair of buttons 134 that can enable to user to set a target air pressure value for an item that is being inflated by the air compressor module 26. When an item is being inflated by the air compressor module 26, the controller 120 can be configured to monitor the air pressure and automatically shut off the pump 116 when the target air pressure value is reached. The control panel 132 can also include a button 136 that enables a user to select the unit of pressure being displayed on the display 133 (e.g., Pascals, atm, or P.S.I.). The air compressor module 26 can also include a power button 138 that can be depressed to turn the pump 116 on and off (e.g., to facilitate selective interruption of the flow of electricity between the pump 116 and the power module 22).

Referring now to FIGS. 5 and 9, the power module 22 can have a plurality of stems 140 (FIG. 5) that extend away from the docking surface 56 substantially orthogonally to the plane P1 and that can be inserted into a plurality of apertures 142 of the interface surface 114 of the air compressor module 26 when the air compressor module 26 is docked on the power module 22. In particular, the stems 140 can interact with the apertures 142 to resist any twisting between the air compressor module 26 and the power module 22. The stems 140 can also cooperate with the plug 122 to facilitate docking of the air compressor module 26 in a direction that is orthogonal to the plane P1 as well as to ensure proper alignment of the air compressor module 26 with respect to the power module 22 during such docking. It is to be appreciated that the power module 22 and/or air compressor module 26 can be provided with any of a variety of suitable alternative or additional mating arrangements that facilitate physical mounting of the air compressor module 26 to the power module 22.

Still referring to FIGS. 5 and 9, the power module 22 can have a pair of interlocking tab members 144 that cooperate with a pair of latches 146 (FIGS. 9 and 10) on the air compressor module 26 to facilitate selective securement of the power module 22 and the air compressor module 26 together. As illustrated in FIG. 5, each of the interlocking tab members 144 can include a base portion 148 and a lateral projecting portion 150. As illustrated in FIG. 9, the interface surface 114 of the air compressor module 26 can define a pair of apertures 151 that align with the interlocking tab members 144 and are configured to receive the interlocking tab members 144 when the air compressor module 26 is docked on the power module 22.

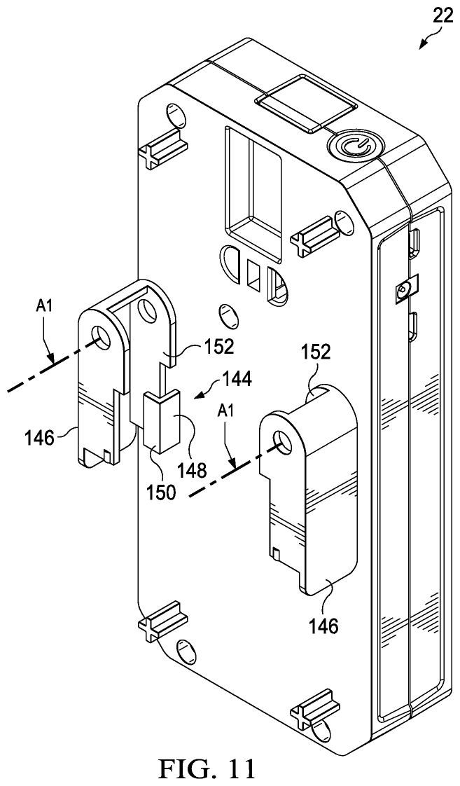

Each of the latches 146 can be pivotally coupled with the housing 110 and pivotable about a respective axis Al (see FIGS. 9 and 11) with respect to the housing 110 between an unlocked position (shown in FIG. 9) and a locked position (FIG. 10). When the latches 146 are in the unlocked position, the air compressor module 26 is free to be docked to, or undocked from, the power module 22. When the latches 146 are in the locked position, the latches 146 engage the interlocking tab members 144 (see FIG. 11) to secure the air compressor module 26 to the power module 22. For example, as illustrated in FIG. 11, each of the latches 146 can include an engagement flange 152. When the latches 146 are in the locked position, as illustrated in FIG. 11, each of the engagement flanges 152 can underlie a respective one of the lateral projecting portions 150 of the interlocking tab members 144 to secure the air compressor module 26 to the power module 22. When the latches 146 are pivoted to the unlocked position, each of the engagement flanges 152 are slid away from the corresponding lateral projecting portion 150 of the interlocking tab members 144, thereby releasing the air compressor module 26 from the power module 22. It is to be appreciated that the power module 22 and/or the air compressor module 26 can include any of a variety of alternative locking mechanisms that are movably coupled with one of the power module 22 and/or the air compressor module 26 and movable between a locked position and an unlocked position to facilitate selective securement of the power module 22 and the air compressor module 26 together.

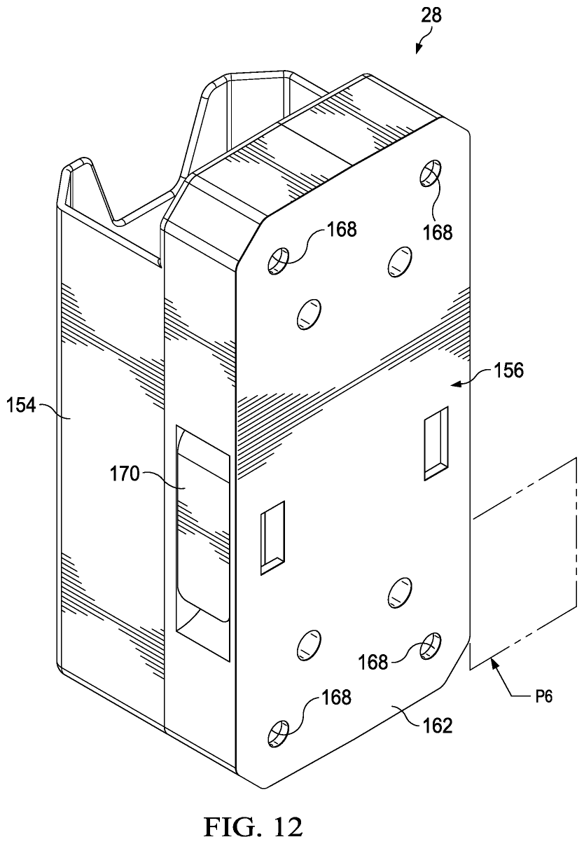

Referring now to FIG. 12, the jumper cable storage module 28 can include a housing 154 that includes a docking interface 156 that is configured to interface with a docking location 158 (FIG. 10) of the air compressor module 26 that is opposite the docking interface 112 for the power module 22. As illustrated in FIG. 10, the docking location 158 of the air compressor module 26 can include a docking surface 160 that is substantially planar and resides in a plane P5. As illustrated in FIG. 12, the docking interface 156 of the jumper cable storage module 28 can include an interface surface 162 that is substantially planar and resides in a plane P6. When the jumper cable storage module 28 is docked on the air compressor module 26, the docking surface 160 and the interface surface 162 can abut such that the plane P5 and the plane P6 are substantially parallel.

As illustrated in FIG. 10, the docking location 158 of the air compressor module 26 can include a plurality of stems 164 and a pair of interlocking tab members 166 that are similar to the respective stems 140 and interlocking tab members 144 described above with respect to the power module 22. As illustrated in FIGS. 2 and 12, the docking interface 156 of the jumper cable storage module 28 can include a plurality of apertures 168 and a pair of latches 170 that are similar to the respective apertures 142 and latches 146 described above with respect to the air compressor module 26.

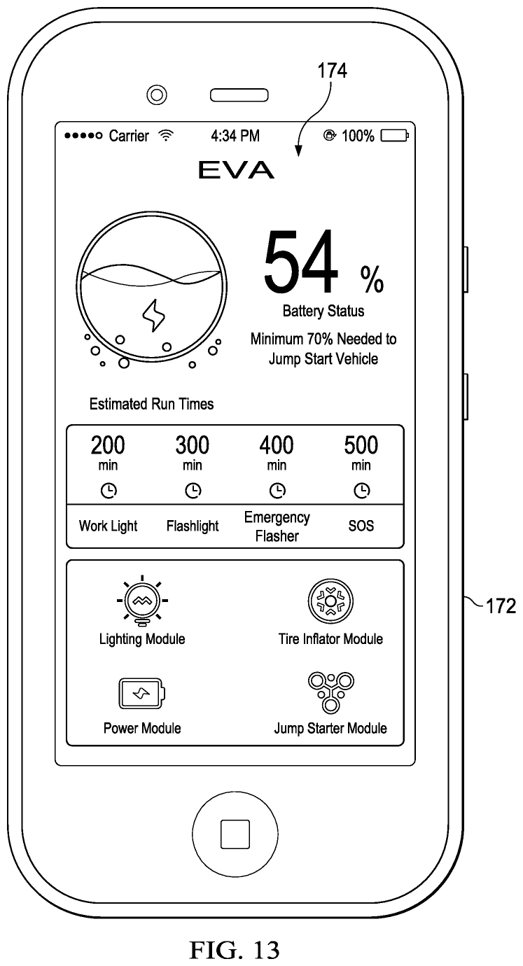

Referring again to FIG. 4, the power module 22 can include a communication module 171 that facilitates wireless (e.g., Bluetooth, NFC, or WiFi) or wired communication with a computing device, such as, for example, a mobile phone 172 as illustrated in FIG. 13. The communication module 171 can facilitate the transmission of various information, such as, for example, stored power level, charging rate, and/or malfunction information to the mobile phone 172 which can present it to a user as a graphical user interface (GUI) 174. The mobile phone 172 can include software, such as a mobile application, that facilitates presentation of the information via the GUI 174 to the user. In one embodiment, the software can provide automatic notifications to the user when the mobile phone 172 is moved into proximity to the multifunction unit 20. For example, when a user carrying the mobile phone 172 is within a certain proximity to the multifunction unit 20, the software on the mobile phone 172 can automatically establish a communication link with the communication module 171 (e.g., via Bluetooth) to begin receiving information from the communication module 171. The software can then notify the user with information that might be useful to the user, such as, for example, that the charge level of the power module 22 has fallen beneath a particular threshold and thus should be charged. The software can also include instructions on the use and implementation of the particular modules that are coupled with the power module 22. The communication module 171 can also be configured to communicate with an onboard communication system of a vehicle so as to receive diagnostic information (e.g., charge level of the vehicle's battery) which can be presented to the user through the GUI 174. It is to be appreciated that although a mobile phone 172 is illustrated and described, any of a variety of suitable alternative computing devices can be used, such as, for example, a laptop computer, a tablet computer, a smart watch, or a desktop computer.

It is to be appreciated that although a light module 24 and an air compressor module 26 are described above, any of a variety of different accessory modules can be selectively and interchangeably attached to, and powered by, the power module 22. In some arrangements, when the accessory modules are attached to the power module 22, additional accessory modules can be connected to the accessory modules that are already attached to the power module 22 (e.g., in a stacking arrangement similar to the mounting of the jumper cable storage module 28 to the air compressor module 26 described above), and all accessory modules can share power from the power module 22, as needed. Each of these accessory modules can provide different functionality to the multifunction unit 20 for use in roadside assistance for a vehicle (e.g., an automobile, boat, truck, recreational vehicle). Some examples of these other types of accessory modules can include an electronic flare, an LED safety vest, a jack, a charging station, an inverting power supply, a communication supply, and an impact wrench. Although the modules described herein primarily relate to providing roadside assistance for a vehicle, it is to be appreciated that different accessory modules can be provided that perform a variety of other functions such as, for example, a radio, a fan, or a heat lamp.

It is to be appreciated that the power module 22 and the accessory modules can together provide a more compact, versatile, portable solution for powering different accessories than conventional arrangements which can be bulky and expensive. For example, certain conventional battery powered arrangements provide only one or two accessories that are not interchangeable with other accessories. Other arrangements use batteries (e.g., nickel cadmium batteries) that are bulky and heavy and thus adversely affect the portability of the unit. The multifunction unit 20 can thus be easily stored in a trunk or other vehicle compartment for retrieval when use of the accessory modules is desired. Furthermore, the accessory modules provided with the power module 22, but that are not attached to the power module 22 during storage, can be provided in a compact bag or carrying case that is easily stored together with the power module 22. In one embodiment, the accessory modules can be connected to the accessory modules that are already attached to the power module 22 (e.g., in a stacking arrangement), and all accessory modules can share power from the power module 22, as needed. In addition, the overall modular design of the multifunction unit 20 can be user-friendly and allow for easy adding and removing of accessory modules (e.g., expandable/contractible) so as to be customizable for a user's specific objective.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended that the scope be defined by the claims appended hereto.

What is claimed is:

1. A multifunction unit comprising:
a power module comprising a power storage device that is configured to store electrical power, the power module further comprising a first docking location;
an accessory module that is configured for selective docking on the power module at the first docking location; and
a locking mechanism movably coupled with one of the power module and the accessory module and movable between a locked position and an unlocked position to facilitate selective securement of the power module and the accessory module together when the accessory module is docked on the power module.

2. The multifunction unit of claim 1 further comprising a locking feature coupled with a different one of the power module and the accessory module than the locking mechanism, wherein:
when the accessory module is docked on the power module and the locking mechanism is in the locked position, the locking mechanism is engaged with the locking feature to secure the power module and the accessory module together; and
when the accessory module is docked on the power module and the locking mechanism is in the unlocked position, the locking mechanism is disengaged from the locking feature to permit undocking of the accessory module from the power module.

3. The multifunction unit of claim 2 wherein the locking mechanism comprises a latch that is pivotally coupled with the accessory module.

4. The multifunction unit of claim 3 wherein the locking feature comprises an interlocking tab member.

5. The multifunction unit of claim 4 wherein:
the first docking location comprises a first surface that is substantially planar and resides in a first plane;
the accessory module comprises a second surface that is substantially planar and resides in a second plane; and
when the accessory module is docked on the power module, the first plane and the second plane are substantially parallel with each other.

6. The multifunction unit of claim 5 wherein the accessory module is docked on the power module in a direction that is substantially orthogonal with at least one of the first plane and the second plane.

7. The multifunction unit of claim 6 wherein:
the accessory module comprises an electrical device; and
the power module comprises a first power output at the first docking location that facilitates delivery of power to the accessory module when the accessory module is docked on the power module at the first docking location.

8. The multifunction unit of claim 7 wherein the electrical device comprises an air compressor module.

9. The multifunction unit of claim 8 further comprising a second docking location that is configured to receive another accessory module.

10. The multifunction unit of claim 9 wherein the another accessory module comprises a non-powered device.

11. The multifunction unit of claim 10 wherein the power module further comprises a second power output a jumper cable that selectively plugs into the second power output to facilitate delivery of power from the power module to an automotive battery.

12. A power module for a multifunction unit, the power module comprising:
a housing comprising:
a first docking location comprising a first surface that is substantially planar and resides in a first plane; and
a second docking location opposite the first docking location and comprising a second surface that is substantially planar and resides in a second plane;
a power storage device disposed at least partially within the housing;
a first power output located at the first surface of the first docking location, the first power output being in electrical communication with the power storage device and configured to deliver power at a first power rating; and
a second power output located at the second surface of the second docking location, the second power output being in electrical communication with the power storage device and configured to deliver power at a second power rating, wherein:
the first surface and the second surface are spaced from each other and are arranged such that the first plane and the second plane are substantially parallel with each other; and
the first power rating is greater than the second power rating.

13. The power module of claim 12 wherein the first power rating is about 60 Watts and the second power rating is about 1.5 Watts.

14. The power module of claim 12 wherein the first power output comprises a socket and the second power output comprises a conductive pad.

15. The power module of claim 12 further comprising:
a third surface that extends between the first surface and the second surface;
a third power output located at the third surface;
the third power output being in electrical communication with the power storage device and configured to deliver power at a third power rating that is greater than the first power rating and the second power rating.

16. The power module of claim 15 wherein the third power rating is about 150 Watts.

17. The power module of claim 12 wherein the power storage device comprises a lithium ion battery.

18. The power module of claim 12 further comprising a mating arrangement at one or more of the first docking location and the second docking location that facilitates physical mounting of an accessory thereto.

19. The power module of claim 18 wherein the mating arrangement comprises a plurality of stems that extends away from one or more of the first surface of the first docking location and the second surface of the second docking location substantially orthogonally to the first plane and the second plane, respectively.

20. The power module of claim 12 further comprising an interlocking tab member that extends from one or more of the first surface of the first docking location and the second surface of the second docking location to facilitate selective securement of an accessory thereto.

21. A multifunction unit comprising:
a power module comprising:
a first housing comprising a docking location;
a first power storage device that is configured to store electrical power; and
a power output located at the docking location and being in electrical communication with the first power storage device; and
a light module that is configured for selective docking on the power module at the docking location, the light module comprising:
a second housing comprising a power module docking interface that interfaces with the power module at the docking location when the light module is docked on the power module;
an illumination device coupled with the second housing and configured to emit light;
a second power storage device at least partially disposed within the second housing and configured to store electrical power, the second power storage device being in electrical communication with the illumination device such that the illumination device is powered from the second power storage device;
a power input located at the power module docking interface, the power input being in electrical communication with the power output of the power module when the light module is docked on the power module such that the second power storage device is powered from the first power storage device; and
a magnetic coupling arrangement associated with each of the power module and the light module to facilitate selective retention of the power module and the light module together when the light module is docked on the power module.

22. The multifunction unit of claim 21 wherein the magnetic coupling arrangement comprises:
a magnet coupled with one of the power module and the light; and
a metal plate coupled with a different one of the power module and the light module than the magnet, wherein the magnet is attracted to the metal plate to hold the light module in place when the light module is docked on the power module.

23. The multifunction unit of claim 21 wherein the light module further comprises a hook pivotally coupled with the second housing at the power module docking interface and selectively pivotable between a stored position and a deployed position.

24. The multifunction unit of claim 21 wherein the light module further comprises a switch in electrical communication with each of the illumination device and the second power storage device and configured to selectively interrupt the flow of electricity between the illumination device and the second power storage device.

25. The multifunction unit of claim 21 wherein the illumination device comprises an array of light emitting diodes.
